(19) United States
(12) Patent Application Publication
(10) Pub. No.: US 2002/0196511 A1
(43) Pub. Date: Dec. 26, 2002

(54) Image projecting device

(76) Inventor: Shi-Hwa Huang, Taipei (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/163,950

(22) Filed: Jun. 5, 2002

(30) Foreign Application Priority Data
Jun. 8, 2001 (TW) 090113997

(51) Int. Cl. G02B 26/08

(52) U.S. Cl. 359/196

(57) ABSTRACT

An image projecting device includes a synchronizing signal generating unit for generating first and second synchronizing control signals. A light source unit is operable so as to generate a plurality of light beams, each having a specific wavelength, and includes a plurality of light emitting diodes that are adapted to be controlled by multiple input signals so as to enable the light beams to have a respective intensity corresponding to a current projected one of multiple pixels of an image frame associated with the input signals. A reflecting unit is controlled by the first and second synchronizing control signals to reflect the light beams from the light source unit onto a corresponding coordinate on a screen for showing the current projected one of the pixels thereon.

### CROSS-REFERENCE TO RELATED APPLICATION

This application claims priority of Taiwan patent Application No. 090113997, filed on Jun. 8, 2001.

### BACKGROUND OF THE INVENTION

1. Field of the Invention

The invention relates to an image projecting device, more particularly to an image projecting device that utilizes a plurality of light emitting diodes as a source of light.

2. Description of the Related Art

FIG. 1 illustrates a conventional cathode ray tube projection display 1 that includes three cathode ray tubes 111. The cathode ray tubes 111 respectively emit red, green and blue light that are converged by three lenses 112 so as to project an image frame onto a screen 12. Due to the use of the cathode ray tubes 111, the projection display 1 provides low power converting efficiency, and has a relatively large size. Only a part of the light emitted from the cathode ray tubes 111 can be projected onto the screen 12 via the lenses 112. To reduce interference from external light sources for presenting a clear image frame, the conventional cathode ray tube projection display 1 should be used at a relatively dark place, thereby resulting in inconvenience during use.

FIG. 2 illustrates a conventional liquid crystal projection display 2 which includes a projecting unit 21 that has a parabolic reflector 212, a light source 211 with high brightness, such as a high-voltage discharge lamp, a plurality of beam splitting lenses 213, 214, 215, and a plurality of liquid crystal panels 216, 217, 218. The parabolic reflector 212 reflects light rays that radiate from the light source 211. The reflected light rays are separated into primary color components, such as red, blue and green color components, by the beam splitting lenses 213, 214, 215. The primary color components pass respectively through the liquid crystal panels 216, 217, 218 and are projected onto a screen 22 via a projection lens 219 Due to the use of the parabolic reflector 212, the beam splitting lenses and the liquid crystal panels 216, 217, 218, the energy utilization rate of the conventional liquid crystal projection display 2 is relatively low. Furthermore, due to the high power consumption and high heat generation of the light source 211, the light source 211 has a relatively short service life.

### SUMMARY OF THE INVENTION

Therefore, the object of the present invention is to provide an image projecting device that utilizes a plurality of light emitting diodes as a source of light and that can overcome the drawbacks associated with the aforesaid prior art.

According to the present invention, an image projecting device is adapted for projecting an image frame associated with a plurality of input signals on a screen. The image frame has a pixel array that includes a plurality of pixels. The image projecting device comprises:

a synchronizing signal generating unit for generating first and second synchronizing control signals;

a light source unit operable so as to generate a plurality of light beams, each having a specific wavelength, the light source unit including a plurality of light emitting diodes that are adapted to be controlled by the input signals so as to enable the light beams to have a respective intensity corresponding to a current projected one of the pixels of the image frame; and

a reflecting unit coupled to the synchronizing signal generating unit for receiving the first and second synchronizing control signals, the reflecting unit being controlled by the first and second synchronizing control signals to reflect the light beams from the light source unit onto a corresponding coordinate on the screen for showing the current projected one of the pixels thereon.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view showing a conventional cathode ray tube projection display;

FIG. 2 is a schematic view showing a conventional liquid crystal projection display;

FIG. 3 is a schematic circuit block diagram illustrating the preferred embodiment of an image projecting device according to the present invention;

FIG. 4 is a schematic side view showing a light source unit of the preferred embodiment;

FIG. 5 is a schematic view showing a pixel array of an image frame projected by the preferred embodiment; and

FIG. 6 is a perspective view showing first and second reflectors of the preferred embodiment.

### DETAILED DESCRIPTION OF THE PREFERRED EMBODIMENT

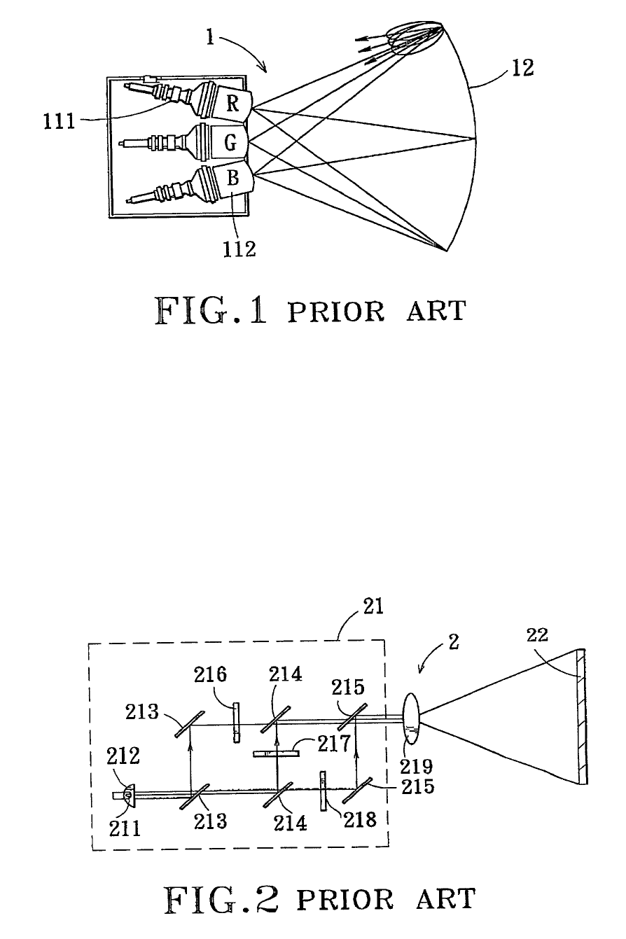

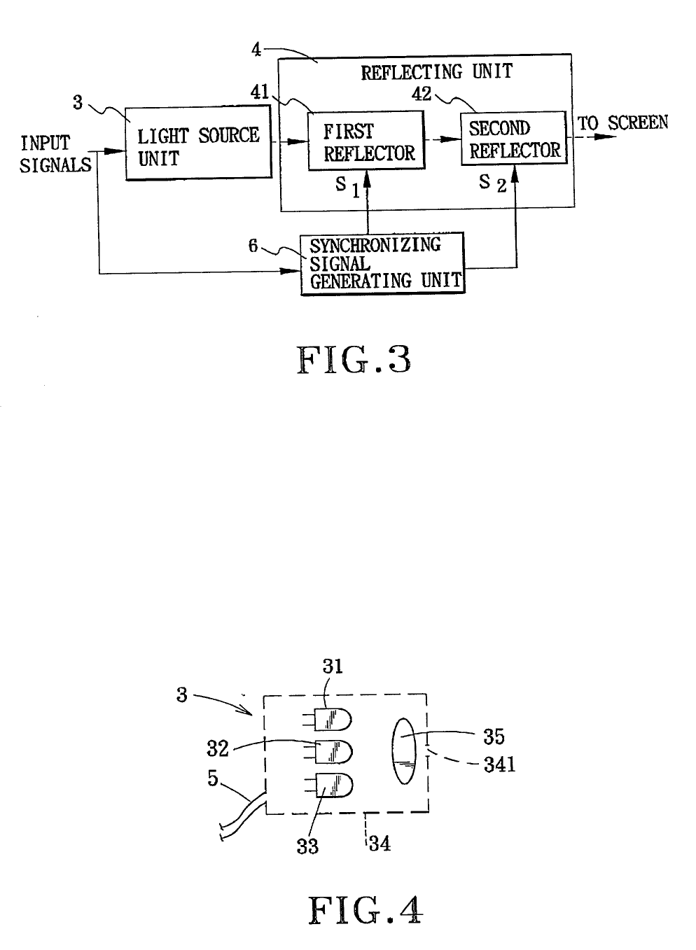

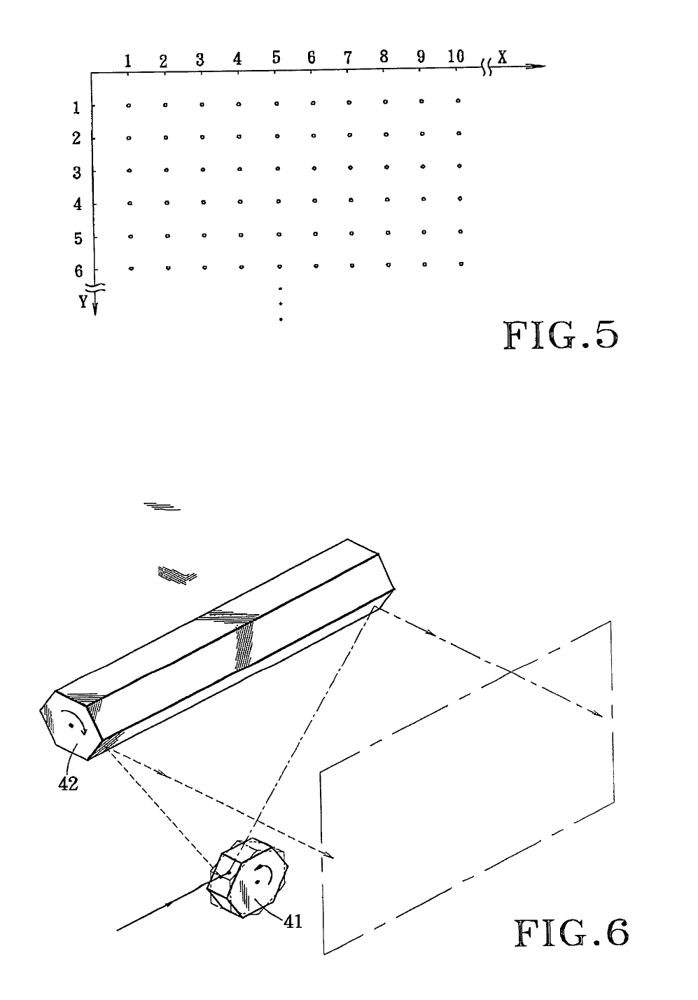

Referring to FIG. 1, according to the preferred embodiment of this invention, an image projecting device is adapted for projecting an image frame associated with a plurality of input signals on a screen (not shown). The image frame has a pixel array (see FIG. 5) that includes a plurality of pixels. The image projecting device includes a synchronizing signal generating unit 6, a light source unit 3, and a reflecting unit 4.

The synchronizing signal generating unit 6 generates first and second synchronizing control signals (S₁, S₂) that are synchronized with the input signals.

The light source unit 3 is operable so as to generate a plurality of light beams, each of which has a specific wavelength. In this embodiment, as shown in FIG. 4, the light source unit 3 includes a diode array having a plurality of light emitting diodes. The light emitting diodes are disposed in a casing 34 that is formed with a through hole 341 for passage of the light beams therethrough, and are adapted to be controlled by the input signals that are received via a signal wire 5 so as to enable the light beams to have a respective intensity corresponding to a current projected one of the pixels of the image frame. The light emitting diodes include a first diode set 31 that emits red light, a second diode set 32 that emits green light, and a third diode set 33 that emits blue light. The first, second and third diode sets 31, 32, 33 include the same number of the light emitting diodes. Each of the first, second and third diode sets 31, 32, 33 can include at least one light emitting diode. When each of the first, second and third diode sets 31, 32, 33 has 255 light emitting diodes, the light source unit 3 can provide 256³ levels of the light beam outputs. In this embodiment, the light source unit 3 further includes a lens 35 facing the light emitting diodes in the casing 34 such that the light beams are substantially parallel as they pass through the through hole 341. It is noted that the light emitting diodes can be replaced by a plurality of laser diodes.

The reflecting unit 4 is coupled to the synchronizing signal generating unit 6 for receiving the first and second synchronizing control signals (S₁, S₂) The reflecting unit 4 is controlled by the first and second synchronizing control signals (S₁, S₂) to reflect the light beams from the light source unit 3 onto a corresponding coordinate on the screen for showing the current projected one of the pixels thereon. For showing the image frame on the screen, the reflecting unit 4 must reflect the light beams corresponding to each of the pixels of the image frame onto the screen at a rate that conforms with vision persistence (about 1/30 second) of human eyes. Interlaced scanning can be used for decreasing the scanning time of an image frame, In other words, the image projecting device of this invention can utilize a known control circuit to select the sampled pixels of the image frame so as to reduce the time for showing the image frame on the screen.

As shown in FIG. 5, the image frame has a 1024×768 pixel array, and can thus present a picture with a high resolution. The coordinate of each of the pixels on the screen includes first and second dimension components. The reflecting unit 4 includes a first reflector 41 for receiving the light beams from the light source unit 3, and a second reflector 42 for receiving the light beams reflected by the first reflector 41 and for reflecting the light beams onto the screen. The first reflector 41 is controlled by the first synchronizing control signal (S₁) so that the current projected one of the pixels can be projected on the screen at the first dimension component of the corresponding coordinate. The second reflector 42 is controlled by the second synchronizing control signal (S₂) so that the current projected one of the pixels can be projected on the screen at the second dimension component of the corresponding coordinate. In this embodiment, each of the first and second reflectors 41, 42 is formed as a multi-faceted columnar mirror, such as a hexagonal columnar mirror (see FIG. 6), and is axially rotatable. The first and second synchronizing control signals (S₁, S₂) are used to control angular rotation of the first and second reflectors 41, 42, respectively. The first reflector 41 is a vertical scanning reflector, and the second reflector 42 is a horizontal scanning reflector. The horizontal scanning reflector 42 is controlled by the first synchronizing control signal (S₁) to rotate at a faster speed than the vertical scanning reflector 41. In this embodiment, the first dimension component serves as the Y-axis component, and the second dimension component serves the X-axis component. Initially, during axial rotation of the second reflector 42 at an angle of 60 degrees, the coordinates of the projected pixels are substantially (1,1), (2,1), (3,1) . . . , (1024,1), respectively. Then, when the first reflector 41 rotates axially by an angle of 60/768 degree, the coordinate of the next projected pixel will be (1,2) As such, by rotating the first and second reflectors 41, 42 in the above manner, the image frame can be presented on the screen. It is noted that, when showing the projected pixels in each horizontal scanning line, the second reflector 42 is simultaneously controlled to rotate by the angle of 60/768 degree such that a height difference exists between the first and last ones of the projected pixels in each horizontal scanning line, thereby resulting in slightly inclined horizontal scanning lines. However, the height difference is generally equal to a distance between adjacent ones of the projected pixels in a vertical direction so that the slightly inclined horizontal scanning lines are hardly noticed by human eyes.

Presently, the switching frequency of a light emitting diode can be as high as 0.5 GHz, and the highest switching frequency of a laser diode, such as a vertical-cavity surface emitting laser diode, can exceed 10 GHz. When the image projecting device of this invention is used to project an image frame with a high resolution (1024×768) at a rate that conforms with vision persistence (about 1/30 second) of human eyes, the frequency of the revolution of the first reflector 41 is 5 Hz, the frequency of the revolution of the second reflector 42 is 6.4 KHz, and the light emitting diodes of the light source unit 3 should be operated with a switching frequency of about 0.024 GHz (1024*768*30=23592960). Therefore, the present technology of light emitting diodes is sufficient to support the industrial utility of the image projecting device of this invention.

The following are some of the advantages of the present invention:

1. The light beams from the light emitting diodes are reflected directly to the screen, thereby resulting in a relatively high light energy utilization rate.

2. The light emitting diodes can be fabricated into a semiconductor chip, thereby resulting in a small size and a relatively low cost.

3. Due to the high light energy utilization rate of the light source, the image projecting device of this invention can be used even at bright places, thereby resulting in convenience during use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An image projecting device for projecting an image frame associated with a plurality of input signals on a screen, the image frame having a pixel array that includes a plurality of pixels, said image projecting device comprising:
a synchronizing signal generating unit for generating first and second synchronizing control signals that are synchronized with the input signals;
a light source unit operable so as to generate a plurality of light beams, each having a specific wavelength, said light source unit including a plurality of light emitting diodes that are adapted to be controlled by the input signals so as to enable the light beams to have a respective intensity corresponding to a current projected one of the pixels of the image frame; and
a reflecting unit coupled to said synchronizing signal generating unit for receiving the first and second synchronizing control signals, said reflecting unit being controlled by the first and second synchronizing control signals to reflect the light beams from said light source unit onto a corresponding coordinate on the screen for showing the current projected one of the pixels thereon.

2. The image projecting device as claimed in claim 1, wherein said light source unit includes a diode array having said light emitting diodes.

3. The image projecting device as claimed in claim 2, wherein said light emitting diodes include a first diode set that emits red light, a second diode set that emits green light, and a third diode set that emits blue light.

4. The image projecting device as claimed in claim 3, wherein said first, second and third diode sets include the same number of said light emitting diodes.

5. The image projecting device as claimed in claim 1, wherein said light source unit further includes a casing having said light emitting diodes disposed therein, said casing being formed with a through hole for passage of the light beams therethrough.

6. The image projecting device as claimed in claim 1, the coordinate of each of the pixels on the screen including first and second dimension components, wherein said reflecting unit includes a first reflector for receiving the light beams from said light source unit, and a second reflector for receiving the light beams reflected by said first reflector and for reflecting the light beams onto the screen, said first reflector being controlled by the first synchronizing control signal so that the current projected one of the pixels can be projected on the screen at the first dimension component of the corresponding coordinate, said second reflector being controlled by the second synchronizing control signal so that the current projected one of the pixels can be projected on the screen at the second dimension component of the corresponding coordinate.

7. The image projecting device as claimed in claim 6, wherein each of said first and second reflectors is formed as a multi-faceted columnar mirror.

8. The image projecting device as claimed in claim 7, wherein each of said first and second reflectors is axially rotatable, the first and second synchronizing control signals being used to control angular rotation of said first and second reflectors, respectively.

9. The image projecting device as claimed in claim 8, wherein one of said first and second reflectors is a horizontal scanning reflector, and the other of said first and second reflectors is a vertical scanning reflector, said horizontal scanning reflector being controlled by the respective one of the first and second synchronizing control signals to rotate at a faster speed than said vertical scanning reflector.
